(19) United States
(12) Patent Application Publication
(10) Pub. No.: US 2005/0236610 A1
(43) Pub. Date: Oct. 27, 2005

(54) Universal weed cover

(76) Inventor: Gary Damon, Dewar, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/829,035

(22) Filed: Apr. 21, 2004

(51) Int. Cl. A01K 3/00

(52) U.S. Cl. 256/13.1

(57) ABSTRACT

A universal weed cover system is installed at the root of a vertical structure of various kinds so as to cover the ground around the structure to prevent the growth of weeds. The universal weed cover is thin, flexible and essentially rectangular. The system comprises a plurality of panels with one or more cut-out sections, sized to fit around the structure. The panels are interconnected and fastened to the ground by fastening means through slot openings at one end of the universal weed cover. The slot openings allow the relative movement of the adjacent covers due to expansion and contraction of the covers caused by ambient heating and cooling. Ribs and/or webs are provided for strength and to channel water off the surface of the panels. A cover is provided when the cut-out opening is greater than the diameter of the vertical structure. The cover has a central flap and is placed over the exposed ground in the post hole and directly on top of the joining universal weed covers.

### BACKGROUND OF THE INVENTION

The present invention relates to a universal weed cover, and more particularly to a weed cover to be placed under and around guardrails or any other similar vertical structures so as to control undergrowth. The main purpose of this device is to provide ground cover and landscaping control to the area immediately under a vertical obstruction of a roadside guardrail so that vegetation does not grow in that area.

Modern roads, highways, and interstates are lined with guardrails for safety purposes. The presence of these guardrails, however, makes it difficult for the highway department to cut or trim the grass under the guardrails and maintain a neat and trimmed look along the roadways. In particular, large tractor type mowers and other maintenance equipment cannot maneuver close enough to the guardrails. If left uncut, the weeds can grow to a point where it obstructs the vision of the driver and also creates an unsightly scene. Often times, resort is made to hand-held devices to trim these areas, which are laborious and time consuming and hence expensive. Another alternative is to spray the area under the guardrails with weed-killers such as Roundup. This requires repeated application of chemicals over time and is not environmentally friendly.

Various devices have been proposed to control weed growth under the guardrails. For example, U.S. Pat. No. 6,276,869 B1 discloses a thin circular plate having a conical surface wherein a post can pass through its central opening. While this device covers an area immediately under individual guardrail posts, it fails to control weed growth between the guardrail posts. A device disclosed in Japanese Pat. No. 08068022 teaches the use of a circular plate and a long plate to prevent weed growth under the guardrails. The circular plate has a central opening to allow a guardrail post to pass through and the long plate is installed between the guardrail posts. This arrangement, however, suffers from a number of problems. First, weeds can grow out of the junction between the two types of plates because there is no overlap between the neighboring plates. Secondly, a perfect alignment between the two members would not allow expansion of the plates in hot weather. Further examples of weed covers include devices disclosed in U.S. Pat. No. 5,285,594 and Japanese Pat. No. 11036252. Both devices involve a plurality of flat cover panels connected with each other to form a belt-like cover for prevention of weed growth. The arrangement of fixating flat panels from end to end does not allow lateral expansion of the flat panels. Furthermore, the flat panel will deform with time due to expansion and contraction caused by solar heat, or physical force exerted when a vehicle gets on it. The edge of the cover panel likely will come off the ground and may be bent to turn upward, and weeds may enter through the bent portion. Still another problem associated with flat cover panels is the accumulation of dirt and other organic matter on the surface of the cover panel. Without regular maintenance, the flat cover panel will be covered with dirt on which grass and weed would grow.

Accordingly, a need exists for an improved ground cover for the area in and around a roadside guardrail.

### SUMMARY OF THE INVENTION

An objective of the present invention is the provision of a universal weed cover that covers and prevents growth of weeds and grass around guardrails and other objects extending upwardly from the ground.

Another objective of the present invention is the provision of a universal weed cover which eliminates the need to mow or trim an area immediately adjacent to a guardrail or any other vertical structures, and which allows for easy mowing and trimming around the perimeter of the cover system.

A further objective of the present invention is the provision of a universal weed cover that eliminates the need to chemically treat an area immediately adjacent to a guardrail or a vertical structure for the purpose of weed control.

Another objective of the present invention is the provision of a universal weed cover that will enhance the overall appearance of the area immediately adjacent to a guardrail with a neat and trimmed outlook.

Still another objective of the present invention is the provision of a universal weed cover having an upper surface textured so as to keep the upper surface free from soil accumulation.

Another objective of the present invention is the provision of a universal weed cover that has interconnecting components and can be easily and quickly installed and repaired.

A further objective of the present invention is the provision of a universal weed cover that allows the lateral expansion and contraction of individual components.

Another objective of the present invention is the provision of a universal weed cover that maintains structural integrity in the presence of environmental and physical forces.

Still another objective of the present invention is the provision of a universal weed cover that is made of recycled plastic and economical to manufacture.

These and other objectives will become apparent from the following description of the invention. To that end, a universal weed cover system for surrounding a series of guardrail posts extending upwardly from the ground so as to protect the area adjacent to the posts is provided. The system comprises a plurality of generally rectangular panels adapted for mating alignment with each other, at least one cut-out section in the panels conforming generally to the shape of the posts, and wherein when the panels are matingly aligned adjacent to the posts to substantially cover the ground around the post and protect from undergrowth.

### BRIEF DESCRIPTION OF THE DRAWINGS

FIG. 1 is a top view of a panel of a universal weed cover system.

FIG. 2 is a perspective view of the panel.

FIG. 3 is an enlarged view of a lower central ribbed portion of the panel.

FIG. 4 is a view of a prior art roadway guardrail.

FIG. 5a is a perspective view of the universal weed cover system placed adjacent to a roadway guardrail.

FIG. 5b is a perspective view of the universal weed cover system adjacent to a roadway guardrail.

FIG. 6 is a perspective view of the universal weed cover system adjacent to a roadway guardrail.

FIG. 7a is top view of a posthole opening cover of the system.

FIG. 7b is a side view of the posthole opening cover.

FIG. 8 is a side view of a clip used to connect the panels.

### DETAILED DESCRIPTION OF THE INVENTION

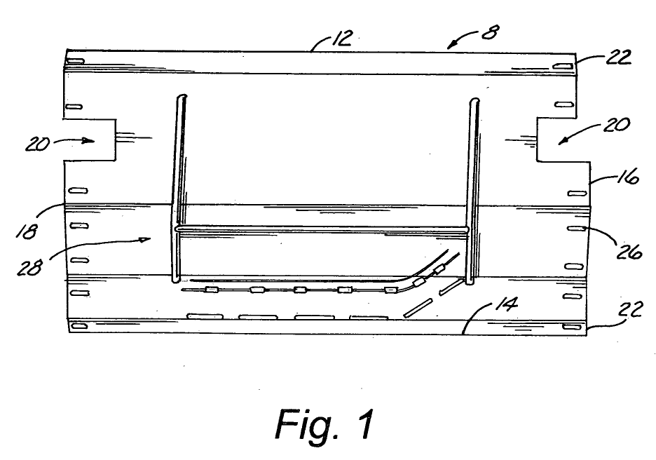

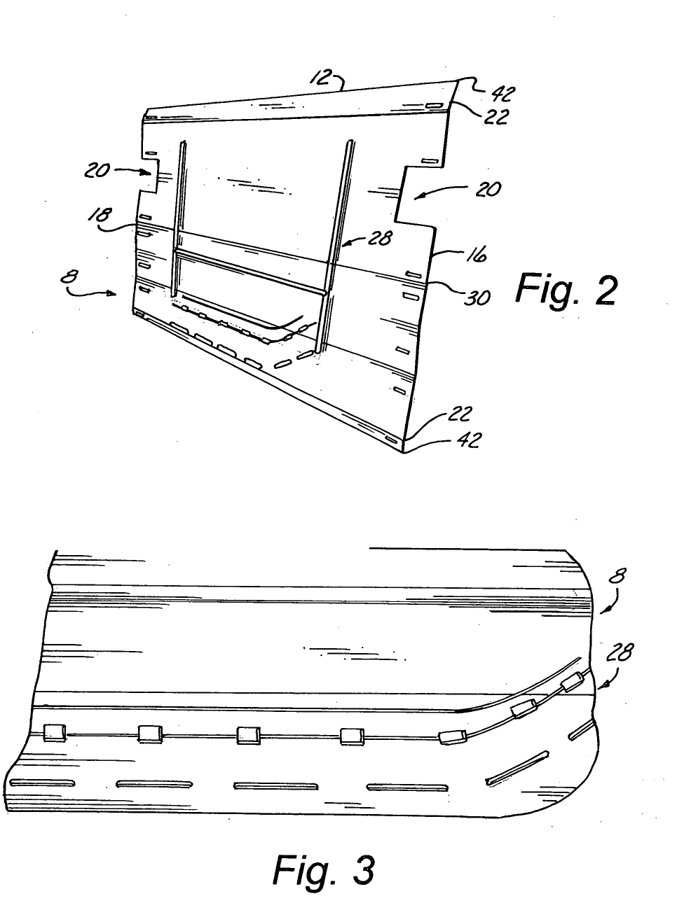

In the Figures, a universal weed cover system 10 is shown, which is designed for use in conjunction with conventional guardrail posts 24 and guardrail 44 located along roadways. The system 10 is comprised of a plurality of panels 8, shown best in FIGS. 1, 2. The panel 10 generally comprises 4 sides, a first side 12 facing the roadway, a second side 14 opposite thereto, and opposing lateral sides 16, 18 having cut-out sections 20 therein. In the preferred embodiment of the invention, the panel 8 is made from 80% recycled and 20% high-density polyethylene plastic with UV protection and 2% carbon black added. The panel 8 measures at 6 feet and 8 inches between the opposing lateral sides 16, 18 and measures 48 inches between the first and second sides 12, 14. The panel 8 is of a generally uniform thickness of 3/16 inches. Of course, those of ordinary skill in the art will understand that the size, thickness, and composition of the panel 8 can and will vary without departing from the scope of the invention.

The first side 12 and second side 14 both include slopped surfaces 22 with slightly curved edges 42 (see FIG. 2), which assist with drainage of water and provide some amount of a seal protecting the underside of the panel 8. The cut-out sections 20 of the panel 8 are offset for mating alignment of the panels 8. As shown best in FIG. 1, the opposing lateral sides 16, 18 are not linear along the lengths of the sides 16, 18. The portion of side 16 below the cut-out 20 extends laterally outward further than the portion of the side 16 above the cut-out 20. In an opposite manner, the portion of side 18 above the cut-out 20 extends laterally outward further than the portion of the side 18 below the cut-out 20. This allow for a better fit around the guardrail posts 24. Alternatively, the panels 8 could include a single cut-out 20 on one side that would align with a straight edge on an adjoining panel 8, or could be linearly arranged along each side of the panel 8.

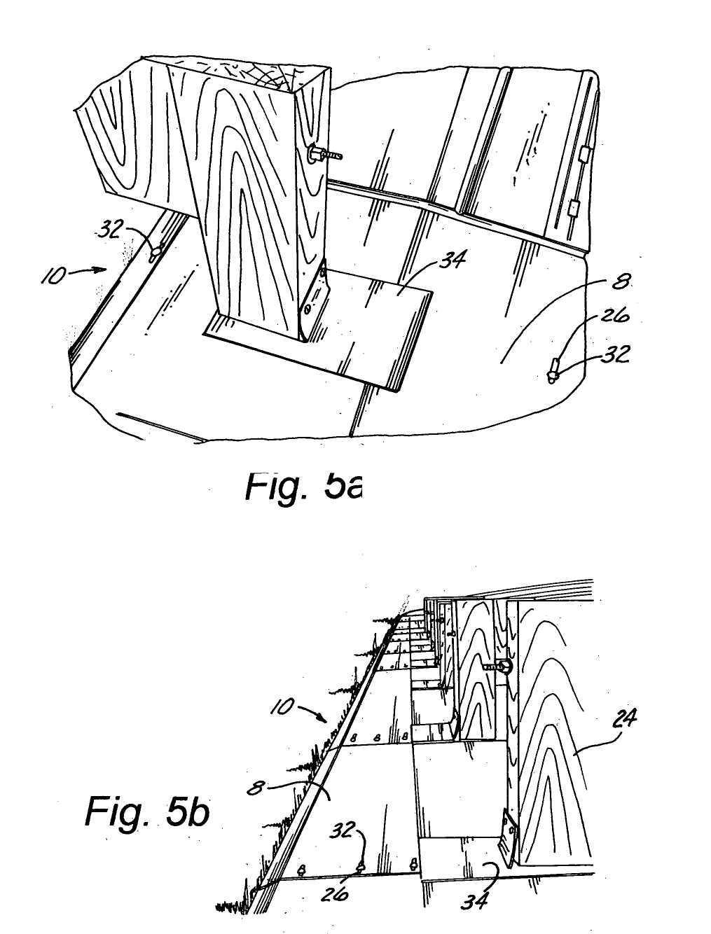

The panels 8 also include a plurality of slots 26. The slots 26 are laterally elongated to allow for expansion of the panels 8 when interconnected. The slots 26 allow for approximately 3 inches of expansion due to variations in ambient heating and cooling, which would otherwise tend to warp of buckle the panels 8. Fasteners 32 secure through the slots 26 to hold the panels 8 in place (see FIG. 5a).

The panel 8 also includes a central crease 30 that provides camber to assist with drainage of water and to adjust to roadside slope. A collection of ribs 28 straddle the crease 30. The ribs 28 help strengthen the panel 8 and help to channel water and dirt from off of the upper surface of the panel 8. The ribs 28 comprise an H-shaped grid and an arced section located below the H-shaped grid near the side 14 (see FIG. 3).

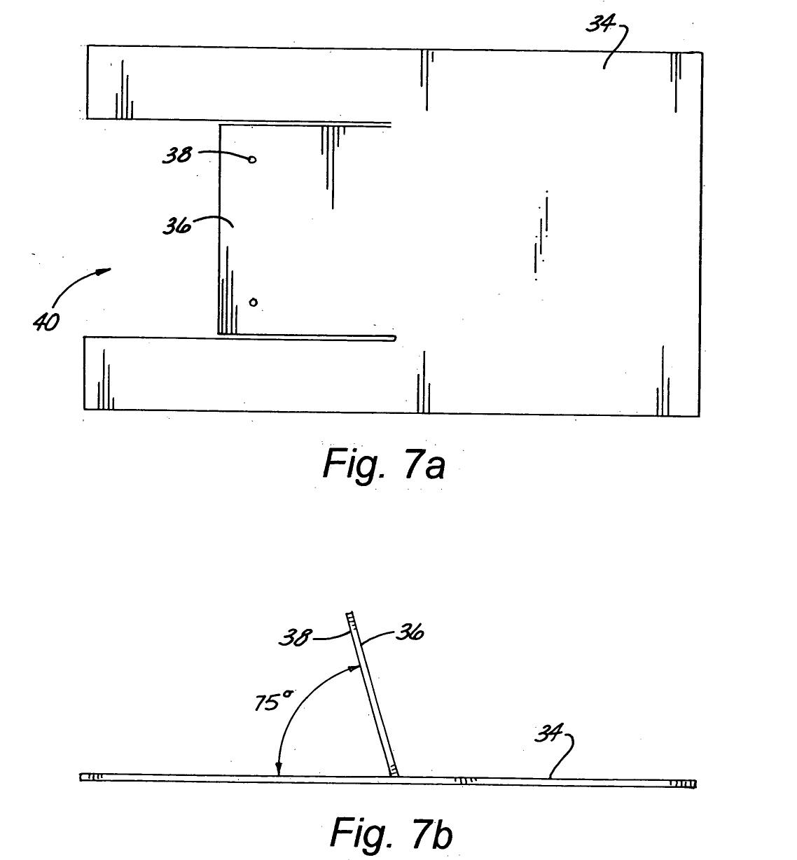

When the panels 8 are in place the system 10 is formed (as shown in FIGS. 5a, 5b, 6). Configured in this manner, a post opening cover 34 secures over the cut-out sections 20 and secures to the guardrail post 24. The cover 34 covers any gap between panels 8 and the guardrail post 24, thereby providing an additional seal around the guardrail post 24. The cover 34 includes a slotted portion 40 sized to fit around the guardrail post 24. A flap 36 secures to the back side of the guardrail post 24 with conventional fasteners like screws or nails. Holes 38 are provided in the flap 36 of the cover 34 for this purpose. As can be seen in FIG. 7a, 7b, the flap 36 of the cover 34 is flexibly hinged at the point were it attaches to the cover 34 allow for easy attachment to the guardrail post 24. The flap 34 may be attached to the panel 8 or to the ground by means of landscaping staples. The flap 36 may not be necessary depending on the size of the guardrail posts 24 in relation to the cut-out sections 20.

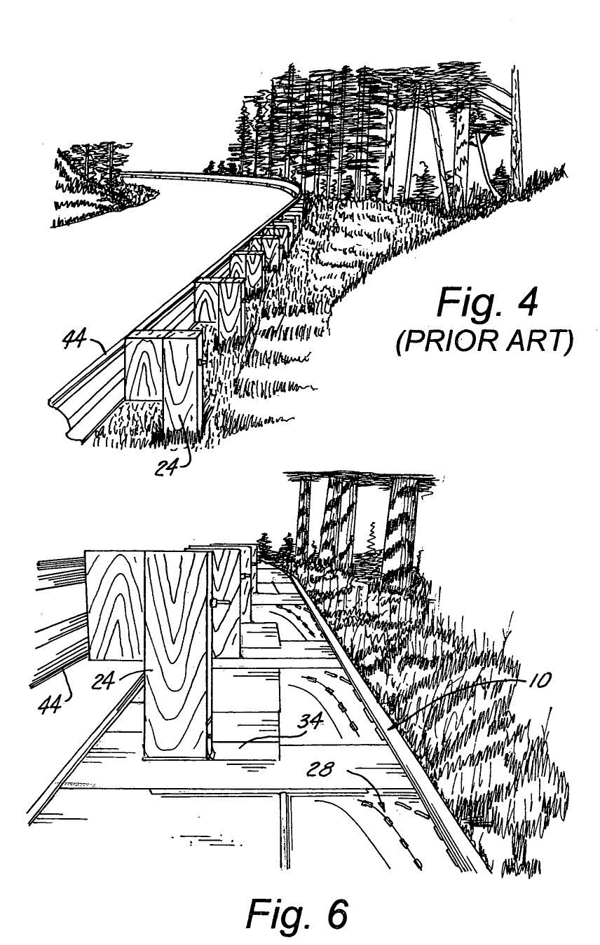

The universal weed cover system 10 is shown in FIGS. 5a, 5b, 6 along a conventional roadway, for contrast FIG. 4 shows a prior art roadway guardrail 44 and guardrail posts 24. As can be seen in Figures, the presence of the guardrail 44 and guardrail posts 24 make it very difficult to maintain the ground underneath. Large tractor type mowers cannot maneuver between the posts 24 or under the guardrail 44. Resort is made to hand-held equipment or chemical treatment of the area under the guardrail. The present invention substantially, if not totally eliminates this problem, wherein the universal weed cover system 10 secures between the guardrail posts 24 as described hereafter. With the system 10 in place, vegetation growth is inhibited and the need for labor-intensive weed trimming and/or chemical means for inhibiting weed growth is unnecessary. Additionally, the roadside on which the guardrail is installed takes on a neat, trimmed look with an enhanced landscaping value.

In order to install the universal weed cover system 10, a first panel 8 is placed on the ground with the cut-out 20 surrounding the guardrail post 24. A second panel 8 is then placed on the ground in mating alignment with the first panel 8 with the prescribed overlap (about 4 inches in the preferred embodiment). The post 24 is thereafter surrounded by the panels 8. The panels 8 are joined by fasteners 32 through the slots 26. The fasteners 32 are push type permanent connectors that are 1 inch long and 5/16 inches in diameter. Once the panels 8 are installed around the guardrail post 24, the covers 8 self-clean with natural precipitation because of the provision of ribs 28 and due to the camber created by crease 30 and sloped surfaces 22 located fore and aft on the panels 8. Configured in this manner the panels 8 also resist accumulation of dirt on the upper surface, and channel water off the surface as well. The curled edges 42 hug the ground and serve to seal the underside of the panel 8 for prevention of light penetration. When installed, the panel 8 covers an area from the line immediately below the guardrail 44 to about 4 feet behind the guardrail 44. The panel 8 does not extend outward from under the guardrail 44 toward the roadway 40, thus allowing room for snow plowing without causing damage to the system 10.

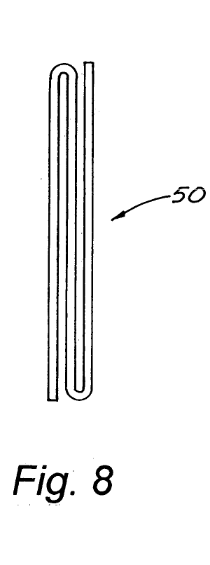

FIG. 8 shows an alternative clip 50 used to secure the panels 8 to each other. The clip 50 is S-shaped and is a sufficient size to allow the panels to move in response to ambient changes in temperature in a manner similar to the use of the slots 26 and fasteners 32. The clips 50 are made of plastic or thermoplastic, like polyethylene, or of a polycarbonate sheet like Lexan. The clips 50 are sized to allow for about six-inches of expansion/contraction of the panels 8, and are elongated such that a single clip 50 traverses about the entire length of the opposing lateral sides 16, 18 of the panels 8.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A universal weed cover system for surrounding a series of guardrail posts extending upwardly from the ground so as to protect the area adjacent to the posts, comprising:
a plurality of generally rectangular panels adapted for mating alignment with each other;
at least one cut-out section in said panels conforming generally to the shape of the posts; and
wherein when said panels are matingly aligned adjacent to the posts to substantially cover the ground around the post and protect from undergrowth.

2. The invention in accordance with claim 1, wherein said panels have two opposing cut-out sections.

3. The invention in accordance with claim 2, wherein said opposing cut-out sections are linearly staggered.

4. The invention in accordance with claim 1, wherein said panels further comprise slots along one edge wherein said panels can be fastened to each other with fasteners secured through said slots.

5. The invention in accordance with claim 4 wherein said slots are elongated to allow for expansion and contraction of said panels in response to changes in temperature.

6. The invention in accordance with claim 1 wherein sail panels further comprise ribs for strengthening said panels and/or for facilitating water drainage.

7. The invention in accordance with claim 1 wherein said panels further comprise an arc shaped ribbed section for strengthening said panels and/or for facilitating water drainage.

8. The invention in accordance with claim 1 wherein said panel further comprises a sloped surface along at least one edge for facilitating drainage and/or for conforming to the shape of the ground.

9. The invention in accordance with claim 8 wherein said panel further comprises two sloped surfaces located fore and aft on aid panel.

10. The invention in accordance with claim 9 wherein said sloped surfaces further comprise curved edges.

11. The invention in accordance with claim 1 wherein said panel further comprises a center crease to camber the panel.

12. The invention in accordance with claim 1 further comprising a cover for covering any gap between the post and said panels.

13. The invention in accordance with claim 12 wherein said cover further comprises a flexible flap for securing said cover to the post.

14. The invention in accordance with claim 1 wherein said panel is made of a flexible material.

15. The invention in accordance with claim 14 wherein said flexible material is plastic.

16. The invention in accordance with claim 14 wherein said plastic is high-density polyethylene plastic.

17. The invention in accordance with claim 15 wherein said plastic is substantially recycled plastic.

18. The invention in accordance with claim 1 further comprising a clip to secure said plurality of panels to each other.
